(19) United States
(12) Patent Application Publication
(10) Pub. No.: US 2010/0312535 A1
(43) Pub. Date: Dec. 9, 2010

(54) UPSCALING OF FLOW AND TRANSPORT PARAMETERS FOR SIMULATION OF FLUID FLOW IN SUBSURFACE RESERVOIRS

(75) Inventors: Yuguang Chen, San Ramon, CA (US); Yan Li, College Station, TX (US)

Correspondence Address: CHEVRON U.S.A. INC.;LAW - INTELLECTUAL PROPERTY GROUP, P.O. BOX 2100, HOUSTON, TX, 77252-2100, US

(73) Assignee: Chevron U.S.A. Inc., San Ramon, CA (US)

(21) Appl. No.: 12/480,212

(22) Filed: Jun. 8, 2009

(51) Int. Cl. G06G 7/48

(52) U.S. Cl. 703/10

(57) ABSTRACT

An upscaling method for efficiently simulating a geological model of subsurface reservoir is disclosed. The method includes providing a fine-scale geological model of a subsurface reservoir associated with a fine-scale grid and a coarse-scale grid. Time-dependent fluid flow solutions, such as fluxes and saturations, are computed for the coarse-scale grid cells. The coarse-scale fluid flow solutions are distributed onto local fine-scale boundaries to obtain local fine-scale boundary conditions. Fine-scale cell fluid flow solutions are computed within the local fine-scale boundaries using the local fine-scale boundary conditions. Two-phase upscaling functions are computed with the fine-scale cell fluid flow solutions and are output to produce a display of fluid flow within the subsurface reservoir.

### FIELD OF THE INVENTION

The present invention is generally directed to simulation of fluid flow in subsurface reservoirs, and more particularly, to upscaling flow and transport parameters to simulate fluid flow in geological models of subsurface reservoirs.

### BACKGROUND OF THE INVENTION

Subsurface reservoirs are typically highly heterogeneous and complex geological formations. High-resolution geological models, which often are composed of millions of grid cells, are generated to capture the detail of these reservoirs. Current reservoir simulators are encumbered by the level of detail available in the fine-scale models and direct numerical simulation of subsurface flow is usually not practical. Upscaling procedures are often employed to coarsen the highly detailed models to scales that are suitable for flow simulation, such that simulation can be performed more rapidly.

A number of upscaling methods are known in the field of reservoir simulation. Generally upscaling techniques take a fine-scale geological model of the subsurface reservoir and generate a corresponding coarse-scale model of the subsurface reservoir that retains a sufficient level of geological realism and allows for fast, yet accurate flow simulations. For example, a fine-scale model may be on a scale that contains 10⁷-10⁸ grid cells while a corresponding coarse-scale simulation model may be on a scale that only contains 10⁴-10⁶ grid cells.

The most commonly applied upscaling technique is often referred to as single-phase flow upscaling, although it can also be applied to two or three-phase flow problems. Single-phase flow upscaling considers only the upscaling of single-phase flow parameters, such as absolute permeability or transmissibility. Upscaling methods that additionally consider transport parameters are often referred to as two-phase or multi-phase upscaling procedures. The upscaling of multiphase transport parameters involves numerical computation of upscaled rock-fluid properties, such as phase relative permeabilities. These upscaling methods are intended to capture the transport of injected fluid and its mobility effects on flow. Multi-phase parameters are more challenging and computationally expensive to compute, as they are represented in the form of time-dependent functions based on phase saturations.

The accuracy of an upscaling method can be significantly affected by the boundary conditions imposed during computation of the upscaled parameters. For example, upscaling approaches can be categorized as local, extended local, global, or quasi-global depending on the region in which boundary conditions are imposed during the upscaling computations.

In local upscaling methods, flow problems are solved on local fine-scale regions, which often correspond to a single coarse-scale grid cell. In extended local upscaling methods, flow problems are solved on slightly larger regions that often correspond to the single coarse-scale grid cell plus a few neighboring coarse-scale grid cells. Local and extended local upscaling methods tend to be computationally efficient as the large-scale global flow problem is decomposed into a series of small-scale local problems. However, local boundary conditions need to be assumed in both methods, which may pose inaccuracy in highly heterogeneous formations where scale separation assumptions are not satisfied. For example, large-scale connectivities may not be sufficiently captured by the boundary conditions in the local or extend local upscaling methods. The issues related to local boundary conditions are even more severe when upscaling two-phase transport functions, as the hyperbolic nature of the saturation equation results in nonlocal effects that evolve in space and time. Methods of local or extended local upscaling for two-phase flow typically result in inaccurate solutions, as the solutions are significantly biased by the local boundary conditions.

In global upscaling methods, fine-scale flow is solved on the entire global domain and upscaled parameters are subsequently computed. The use of local boundary conditions is eliminated, thus typically increasing the accuracy of the solution. However, global upscaling methods are computationally expensive as global fine-scale flow must be computed. When dealing with two-phase flow, although global two-phase upscaling methods exist, they are generally not feasible in practice as they require solving full fine-scale time-dependent two-phase flow—exactly what upscaling techniques seek to avoid.

In efforts to avoid solving global fine-scale two-phase flow while still accounting for global flow effects, quasi-global upscaling methods have been developed. Quasi-global upscaling methods can be considered a hybrid between local and global upscaling methods. Quasi-global upscaling methods approximate global flow effects and incorporate them into local upscaling calculations. Quasi-global approaches therefore, combine the advantages of both local and global methods by attempting to provide a balance between the efficiency and accuracy in upscaling calculations.

A recently developed quasi-global upscaling method utilizes effective flux boundary conditions (EFBCs). Effective flux boundary conditions estimate local fluxes based on local fine-scale and global background permeabilities. Boundary conditions for the pressure equation are adjusted by computing the inlet and outlet local fluxes based on the local fine-scale permeability, while global effects are approximately accounted for through the global background permeability. While in some cases this quasi-global upscaling method corrects the bias induced by standard local boundary conditions in the coarse-scale model, it often leads to unsatisfactory flow predictions. Other quasi-global methods have also been generated; however, they have encountered similar problems.

### SUMMARY OF THE INVENTION

According to an aspect of the present invention, a quasi-global two-phase method for upscaling a fine-scale geological model of a subsurface reservoir having two-phase fluid flow is disclosed. The method includes providing a fine-scale geological model of a subsurface reservoir associated with a fine-scale grid having a plurality of fine-scale cells and a coarse-scale grid having a plurality of coarse-scale cells. Fluxes and saturations are calculated for the coarse-scale cells, and are distributed onto local fine-scale boundaries to obtain local fine-scale boundary conditions. Fine-scale cell fluid flow solutions within the local fine-scale boundaries are calculated subject to the local fine-scale boundary conditions. Two-phase upscaling functions are calculated based on the fine-scale cell fluid flow solutions and the two-phase upscaling functions are output to produce a display of fluid flow within the subsurface reservoir.

The calculated fluxes and saturations are time-dependent. In some embodiments, the fluxes and saturations can be calculated using a primitive coarse-scale model. In some embodiments, this method is iteratively repeated subsequent to updating the fluxes and saturations by solving coarse-scale flow using the computed two-phase upscaling functions. In some embodiments, the fluxes and saturations can be distributed onto local fine-scale boundaries using a time-of-flight interpolation scheme.

The fine-scale cell fluid flow solutions are averaged or integrated to calculate the two-phase upscaling functions. The calculated two-phase upscaling functions can include fractional flow and total flow functions.

Another aspect of the present invention includes a computer-implemented method for upscaling a fine-scale geological model of a subsurface reservoir having two-phase fluid flow. The method includes providing a fine-scale geological model of a subsurface reservoir associated with a fine-scale grid having a plurality of fine-scale cells and a coarse-scale grid having a plurality of coarse-scale cells. Time-dependent coarse-scale cell fluid flow solutions are computed at a coarse-scale time-step. The coarse-scale cell fluid flow solutions at the coarse-scale time-step are distributed onto local fine-scale boundaries to obtain local fine-scale boundary conditions. Fine-scale cell fluid flow solutions within the local fine-scale boundaries are computed at a fine-scale time-step subject to the local fine-scale boundary conditions. Time-dependent coarse-scale cell two-phase fluid flow functions are computed from the fine-scale cell fluid flow solutions. A display of fluid flow within the subsurface reservoir is produced based on the time-dependent coarse-scale cell two-phase fluid flow functions.

In some embodiments, this method is iteratively repeated by solving coarse-scale flow using the computed time-dependent coarse-scale cell two-phase fluid flow functions and updating the time-dependent coarse-scale cell fluid flow solutions.

In some embodiments, the fine-scale time step is advanced and the steps of computing the fine-scale cell fluid flow solutions at a fine-scale time-step and computing the time-dependent coarse-scale cell fluid flow functions based on the fine-scale cell fluid flow solutions are repeated when an average of the fine-scale cell fluid flow solutions is less than the time-dependent coarse-scale cell fluid flow solutions at the following time step.

In some embodiments, the steps of obtaining local fine-scale boundary conditions, computing the fine-scale cell fluid flow solutions using the local fine-scale boundary solutions, computing time-dependent coarse-scale cell fluid flow functions based on the fine-scale cell fluid flow solutions, and outputting a display of fluid flow are repeated when an average of the fine-scale cell fluid flow solutions is greater than or equal to the time-dependent coarse-scale cell fluid flow solutions at the following time step.

Another aspect of the present invention includes a system for upscaling a fine-scale geological model of a subsurface reservoir having two-phase fluid flow. The system includes a database, a computer processor, a software program, and a visual display. The database is configured to store data including a fine-scale geological model of a subsurface reservoir, which is associated with a fine-scale grid having a plurality of fine-scale cells and a coarse-scale grid having a plurality of coarse-scale cells. The computer processer is configured to receive the stored data from the database and to execute software based on the stored data. The software program is executable on the computer processer and is configured for computing coarse-scale cell fluid flow solutions, distributing the coarse-scale cell fluid flow solutions onto local fine-scale boundaries to obtain local fine-scale boundary conditions, computing fine-scale cell fluid flow solutions within the local fine-scale boundaries using the local fine-scale boundary conditions, and computing two-phase upscaling functions based on the fine-scale cell fluid flow solutions. The visual display can display outputs from the system, such as fractional flow and total flow functions.

### BRIEF DESCRIPTION OF THE DRAWINGS

FIG. 1(A) illustrates global coarse-scale flow through a local region in a global domain representative of a subsurface reservoir, in accordance with the present invention.

FIG. 1(B) illustrates local fine-scale flow in the local region shown in FIG. 1(A), in accordance with the present invention.

FIG. 2 is a schematic illustrating how local boundary conditions are updated based on global coarse-scale saturation and averaged local fine-scale saturation, in accordance with the present invention.

FIG. 3 is a flowchart illustrating steps of an upscaling method, in accordance with the present invention.

FIG. 4 is a schematic diagram of a system that can perform upscaling, in accordance with the present invention.

FIGS. 5(A-D) illustrate permeability distributions shown in logarithmic scale with various correlation lengths.

FIG. 6(A) illustrates total flow rates in the permeability distribution shown in FIG. 5(A), in accordance with the present invention.

FIG. 6(B) illustrates fractional flow in the permeability distribution shown in FIG. 5(A), in accordance with the present invention.

FIG. 7(A) illustrates total flow rates in the permeability distribution shown in FIG. 5(B), in accordance with the present invention.

FIG. 7(B) illustrates fractional flow in the permeability distribution shown in FIG. 5(B), in accordance with the present invention.

FIG. 8(A) illustrates total flow rates in the permeability distribution shown in FIG. 5(C), in accordance with the present invention.

FIG. 8(B) illustrates fractional flow in the permeability distribution shown in FIG. 5(C), in accordance with the present invention.

FIG. 9(A) illustrates total flow rates in the permeability distribution shown in FIG. 5(D), in accordance with the present invention.

FIG. 9(B) illustrates fractional flow in the permeability distribution shown in FIG. 5(D), in accordance with the present invention.

FIG. 10(A) illustrates total flow rates in the permeability distribution shown in FIG. 5(D) with a high mobility ratio, in accordance with the present invention.

FIG. 10(B) illustrates fractional flow in the permeability distribution shown in FIG. 5(D) with a high mobility ratio, in accordance with the present invention.

FIG. 11(A) illustrates total flow rates in the permeability distribution shown in FIG. 5(A) with a high mobility ratio, in accordance with the present invention.

FIG. 11(B) illustrates fractional flow in the permeability distribution shown in FIG. 5(A) with a high mobility ratio, in accordance with the present invention.

FIG. 12(A) illustrates one hundred realizations of fractional flow in the permeability distribution shown in FIG. 5(A) for a fine-scale model.

FIG. 12(B) illustrates one hundred realizations of fractional flow in the permeability distribution shown in FIG. 5(A) for a primitive coarse-scale model.

FIG. 13(A) illustrates confidence intervals for fractional flow in the permeability distribution shown in FIG. 5(A) for a fine-scale model and a primitive coarse-scale model.

FIG. 13(B) illustrates confidence intervals for fractional flow in the permeability distribution shown in FIG. 5(A) for a fine-scale model and a coarse-scale model obtained using upscaling with effective flux boundary conditions (EFBCs).

FIG. 13(C) illustrates confidence intervals for fractional flow in the permeability distribution shown in FIG. 5(A) for a fine-scale model and a coarse-scale model obtained using local-global two-phase upscaling, in accordance with the present invention.

### DETAILED DESCRIPTION OF THE INVENTION

Embodiments of the present invention described herein are generally directed to a quasi-global two-phase upscaling method, particularly for use in a reservoir simulator. As used herein, the term “quasi-global”refers to upscaling methods that incorporate approximate global flow information into local upscaling calculations. As will be described herein in more detail, global coarse-scale two-phase solutions are directly incorporated into local two-phase upscaling calculations. Accordingly, the impact of global flow is effectively captured, both spatially and temporally, while global two-phase fine-scale simulations are avoided.

The interactions of two immiscible fluid phases in porous media, such as oil and water in a subterranean reservoir, can be mathematically expressed by Darcy's Law and the mass conservation equation. Neglecting the effects of capillarity and gravity, Darcy's law can be stated as:

$${u}_{j} = - \frac{{k}_{rj}}{{μ}_{j}} k ( x ) \cdot ∇ p \qquad Equation 1$$

where k is the absolute permeability tensor, which can be highly variable in space x, pressure is designated by p, the subscript j designates the fluid phase (here, j=w for water and j=o for oil), Uⱼ is the Darcy velocity for phase j, μⱼ is the phase viscosity, and kᵣⱼ is the relative permeability to phase j. Assuming the incompressibility of rock and fluids, and in the absence of source terms, the mass conservation equation for phase j can be expressed:

$$φ \frac{\partial {S}_{j}}{\partial t} + ∇ \cdot {u}_{j} = 0 \qquad Equation 2$$

where φ is porosity, t is time, and Sⱼ is the saturation (volume fraction) of phase j. Note that S_{w}+Sₒ=1. The relative permeabilities kᵣⱼ, as appearing in Equation 1, are typically functions of water saturation, which is designated S_{w}.

Darcy's law and the mass conservation equation can be manipulated to be written as pressure and saturation equations:

$$\begin{matrix}∇ \cdot [ λ ( S ) k ( x ) \cdot ∇ p ] = 0 & Equation 3 \\ φ \frac{\partial S}{\partial t} + ∇ \cdot [ uf ( S ) ] = 0 & Equation 4\end{matrix}$$

where λ is total mobility, which is defined as λ=λ_{w}+λₒ=k_{rw}/μ_{w}+kᵣₒ/μₒ, and S is used to represent S_{w} for simplicity. The total Darcy velocity u can be computed via u=λk·∇p. The quantity ƒ is the Buckley-Leverett fractional flow function, which is computed as ƒ=λ_{w}/(λ_{w}+λₒ). Note that both λ and ƒ are functions of kᵣⱼ(S). Equations 3 and 4 are also commonly referred to as flow and transport equations.

The above equations describe a two-phase flow model on a fully resolved or fine scale. The purpose of upscaling is to develop appropriate coarse-scale models, which are defined by coarse-scale coefficients determined via upscaling. Exact coarse-scale equations can be obtained through volume averaging of fine-scale Equations 3 and 4, which gives:

$$\begin{matrix}∇ \cdot \overline{[ λ ( S ) k ( x ) \cdot ∇ p ]} = 0 & Equation 5 \\ \overline{φ} \frac{\partial \overline{S}}{\partial t} + ∇ \cdot \overline{[ uf ( S ) ]} = 0 & Equation 6\end{matrix}$$

The overline in Equations 5 and 6 represents volume averaging. Equations 5 and 6 are obtained by applying ∇·( )=∇·( ), which is satisfied when the average is over orthogonal or rectangular grid cells, and by assuming the porosity φ is a constant. The averaging of nonlinear terms in the above equations yields additional terms or higher order moments in the coarse-scale equations. Different treatments of the nonlinear terms, λk·∇p and uƒ, lead to different upscaling procedures.

In practice, the coarse-scale models are often taken to be the same form as the fine-scale model given by Equations 3 and 4, but with the fine-scale parameters being replaced by coarse-scale quantities. Therefore, the coarse-scale models can be expressed as

$$\begin{matrix}∇ \cdot [ {λ}^{*} ( {S}^{c} ) {k}^{*} ( x ) \cdot ∇ {p}^{c} ] = 0 & Equation 7 \\ φ \frac{\partial {S}^{c}}{\partial t} + ∇ \cdot [ {u}^{c} {f}^{*} ( {S}^{c} ) ] = 0 & Equation 8\end{matrix}$$

where the superscript * designates upscaled coarse-scale quantities and the superscript c represents volume-averaged coarse-scale variables. The upscaled quantities are computed through appropriate numerical procedures so that the coarse-scale variables to be solved in Equations 7 and 8 are as close as possible to the fine-scale solution.

The upscaled quantities can be categorized into upscaled single-phase flow parameters and upscaled multiphase flow functions. When the coarse-scale model involves only the upscaled single-phase parameters of permeability (k*) or transmissibility (T*), which is analogous to permeability in a discrete form, the model can be referred to as a primitive coarse-scale model. In other words, the fine-scale relative permeability functions are retained in the coarse-scale model such that ƒ*=ƒ and λ*=λ. The primitive model does not account for the transport effects in the upscaled model. The primitive model may be applicable for cases in which the subgrid permeability heterogeneity is small, such as cases with moderate coarsening level or non-uniform grids to minimize heterogeneity within coarse-scale cells.

In more general cases, especially with large upscaling ratios, the upscaled two-phase functions, λ*(S^{c}) and ƒ*(S^{c}) in Equations 7 and 8, need to additionally be considered. Note that the representation λ*(S^{c}) and ƒ*(S^{c}) in the coarse-scale model is equivalent to the use of upscaled relative permeability functions kᵣⱼ*(S^{c}).

Equations 7 and 8 only represent one form of the coarse-scale model and other models that represent the subgrid effects due to the nonlinear terms could be used. For example, a generalized convection-diffusion model, which introduces a diffusive term to model the subgrid effects in Equation 6 and the convective correction as shown in Equation 8, could be utilized. In this model both the diffusive and convective terms need to be numerically determined, analogous to the computation of λ*(S^{c}) and ƒ*(S^{c}) shown herein. Therefore, the issue of global flow dependency of the upscaled terms also exists in the generalized convection-diffusion model. As was previously discussed herein, the accuracy of the coarse-scale model and the efficiency of the upscaling procedures depend to a large extent on how the upscaled two-phase functions are computed.

In the quasi-global two-phase upscaling method of the present invention, local boundary conditions are directly determined from global coarse-scale solutions. This method shall therefore be referred to herein as a local-global two-phase (LG2P) upscaling method. This local-global method effectively incorporates global flow effects in local calculations and avoids solving global fine-scale two-phase flow, which is required in standard global upscaling methods. However, in two-phase upscaling, both global coarse-scale and local fine-scale simulations are time-dependent, which poses more challenges.

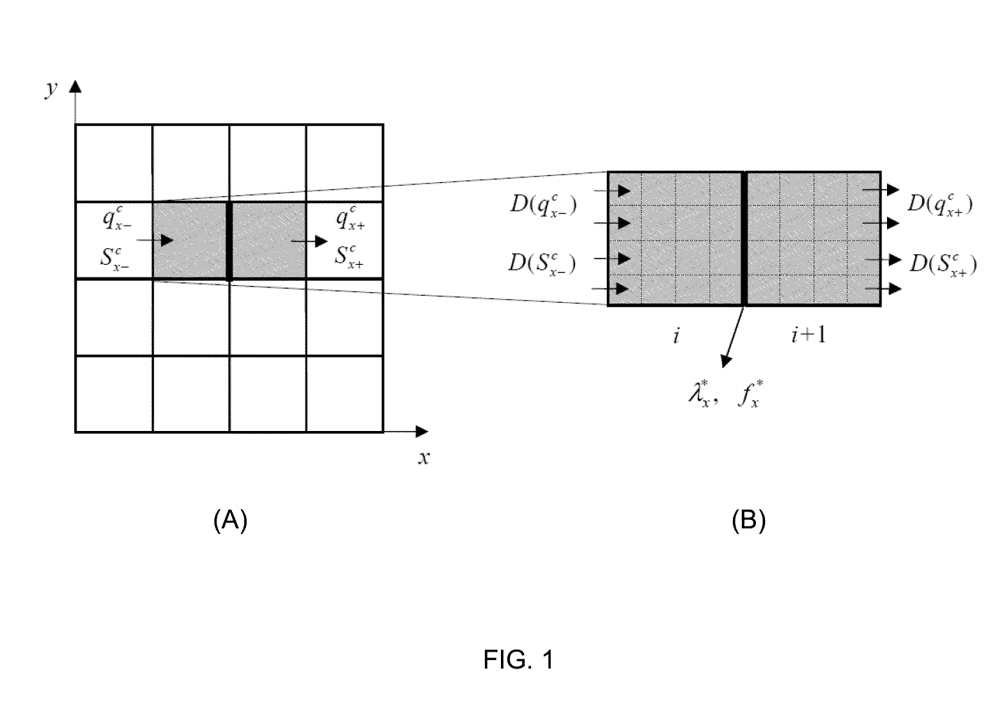

FIG. 1 schematically illustrates the local-global two-phase upscaling method. A global coarse-scale flow is shown in FIG. 1(A), and the shaded region represents a local region embedded in the global domain. Local fine-scale flow, solved on the local region, is presented in FIG. 1(B). The global coarse-scale and local fine-scale flow simulations are coupled through local boundary conditions. The global coarse-scale solutions are interpolated onto the local fine-scale boundaries. In addition, the local fine-scale boundary conditions are updated according to the time-dependent coarse-scale solutions.

The arrows in FIG. 1(A) designate coarse-scale fluxes (q^{c}) and saturations (S^{c}) obtained from global coarse-scale simulation. They are defined at the inlet (x₋) and outlet (x₊) edges of the local domain. These coarse-scale quantities are distributed onto the local fine-scale boundaries based on fine-scale permeability heterogeneities. As will be described herein, an interpolation scheme based on time of flight (TOF) from fine-scale single-phase streamline calculations is used to distribute the coarse-scale quantities onto the local fine-scale boundaries. However, one skilled in the art will appreciate that other interpolation schemes may be used.

In streamline simulations, time of flight is described as the travel time of a tracer particle along a streamline. This can be expressed mathematically as

$${u}_{s} \frac{\partial τ}{\partial s} = φ \qquad Equation 9$$

where τ denotes the time of flight, s designates the streamline coordinate, uₛ is the Darcy velocity tangential to the streamline, and φ is the porosity. From Equation 9, the time of flight at location (x, y) can be computed via

$$τ ( x , y ) = {\int }_{inlet}^{( x , y )} \frac{φ}{{u}_{s}} d s = {\int }_{inlet}^{( x , y )} \frac{1}{\frac{{u}_{s}}{φ}} d s \qquad Equation 10$$

where uₛ/φ is referred to as interstitial velocity (tangential to the streamline). Therefore, time of flight can be viewed as the distance along a streamline divided by the particle velocity. Streamline function ψ, which satisfies ∇×ψ=u, is computed from global single-phase fine-scale velocities. Then along streamlines, time of flight can be calculated using standard al-gorithms known in the art. Note that the time of flight, τ, is inversely proportional to the velocity along the streamline, thus depending on fine-scale permeability heterogeneities.

The local fine-scale region shown in FIG. 1(B) contains nₓ×n_{y} fine-scale cells and is indexed by (i,j). At the inlet edge (x₋), the coarse-scale fluxes and saturations (qₓ₋^{c} and Sₓ₋^{c}) are apportioned to the local fine-scale boundaries via

$$\begin{matrix}{( {q}_{j}^{f} )}_{x -} = \frac{{τ}_{max} - {τ}_{j}}{{τ}_{max} - {τ}_{min}} {\vert}_{x -} {q}_{x -}^{c} , 1 \leq j \leq {n}_{y} & Equation 11 \\ {( {S}_{j}^{f} )}_{x -} = \frac{{τ}_{max} - {τ}_{j}}{{τ}_{max} - {τ}_{min}} {\vert}_{x -} {S}_{x -}^{c} , 1 \leq j \leq {n}_{y} & Equation 12\end{matrix}$$

where the superscript c and ƒ designate coarse-scale and fine-scale quantities, τₘₐₓ and τₘᵢₙ represent the maximum and minimum values of τ along the fine-scale boundary x₋, and j is the fine-scale index along the local boundary. Analogously, the fine-scale fluxes and saturations at the outlet boundary x₊are obtained from q^{c}, S^{c}, and the fine-scale single-phase quantities τ at the local boundary x₊. No-flow boundary conditions are imposed for the two boundaries that are parallel to the flow direction.

Time of flight itself actually carries global transport information for single-phase tracer flow. The normalization in Equations 11 and 12 localizes the values of time of flight, such that the distribution of q^{c} and S^{c} only depends on the local fine-scale heterogeneity. Global dependency is incorporated through the direct use of global coarse-scale solutions q^{c} and S^{c}, which vary spatially. Other quantities, such as fine-scale single-phase velocities, permeabilities and intercell transmissibilities, can also be applied to interpolate the coarse-scale fluxes and saturations, though they are not shown here.

The global flow dependency in two-phase upscaling exists both temporally and spatially. Implementation of the time-dependent global coarse-scale solutions (q^{c} and S^{c}) is a challenge not encountered in single-phase flow upscaling calculations. To incorporate temporal global flow information, the local boundary conditions need to be updated in accordance with the coarse-scale solutions during the course of local fine-scale simulation. A key issue lies in that the discrete time steps involved in the global coarse-scale simulation and the local fine-scale simulation are different. A criterion can be used that attempts to keep the change of local fine-scale saturation (in an average sense) approximately the same as that of the global coarse-scale solution.

For a local domain, the saturation on the inlet boundary can be denoted as S_{bc} and the saturation in the interior domain can be denoted as Sᵢₙ. Then S_{bc}^{c} and Sᵢₙ^{c} represent those values from the global coarse-scale solution, and S_{bc}^{ƒ} and Sᵢₙ^{ƒ} designate the integrated fine-scale saturation on the botmdary and the averaged saturation in the interior region. For simplicity, <·> is not used here to represent the integrated/averaged quantities. The boundary saturation can be written as a function of the interior saturation, which gives S_{bc}(Sᵢₙ). In local-global two-phase upscaling, the local fine-scale saturation boundary conditions are obtained from the global coarse-scale solution, which yields

S_{bc}^{ƒ}(Sᵢₙ^{ƒ})=S_{bc}^{c}(Sᵢₙ^{c}) Equation 13

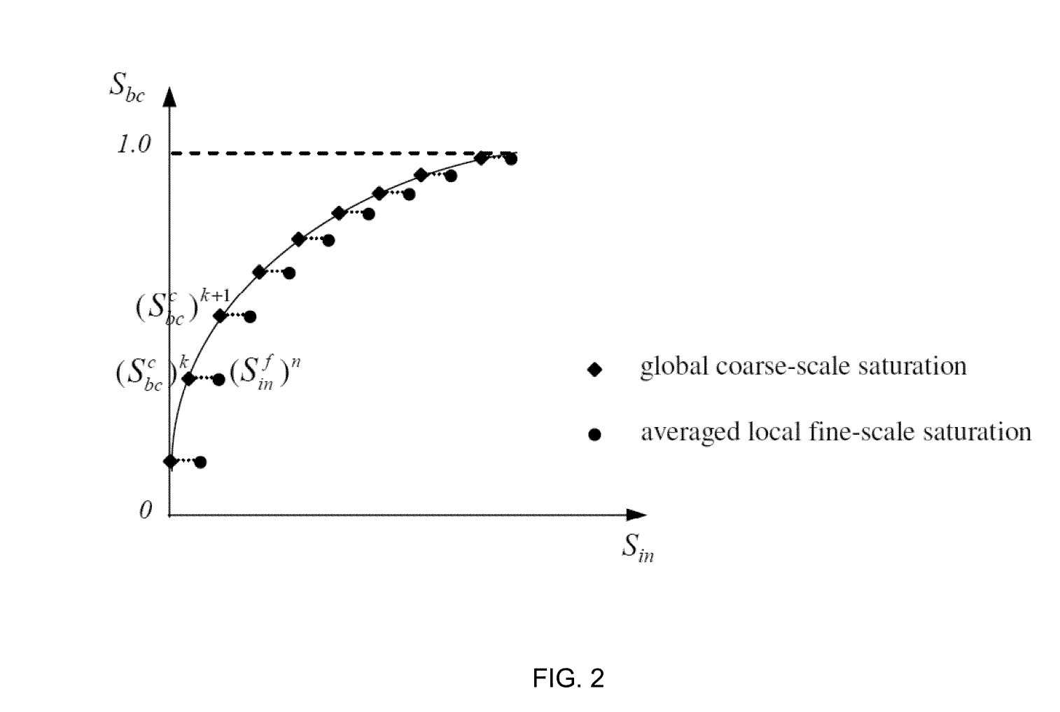

FIG. 2 schematically shows an update of local botmdary conditions. A functional relationship is displayed between the saturation at the inlet boundary and in the interior domain. The time-dependent global coarse-scale saturation can be represented by a series of solutions. As shown in FIG. 2, the boundary saturation from the global coarse-scale solution is designated as (S_{bc}^{c})^{k}, where k represents a time step in the global coarse-scale simulation, at which the coarse-scale solution is output. The (averaged) fine-scale saturation (over a coarse-scale cell) from the local fine-scale simulation is denoted as (Sᵢₙ^{ƒ})ⁿ, where n is the time step in the local fine-scale simulation.

In the local fine-scale simulation, for a given boundary saturation (S_{bc}^{c})^{k}, which is used to determine the local fine-scale boundary conditions, the interior saturation (Sᵢₙ^{ƒ})ⁿ will increase with the advances of time step n. This is schematically illustrated by the dotted horizontal lines in FIG. 2. When (Sᵢₙ^{ƒ})ⁿ reaches the value of its corresponding coarse-scale saturation for the given coarse-scale cell at the next step (Sᵢₙ^{c})^{k+1}, the boundary saturation at k+1, (S_{bc}^{c})^{k+1}, will then be used to determine the local fine-scale boundary conditions. Thus the criterion to update the boundary conditions can be expressed as

(Sᵢₙ^{ƒ})ⁿ≧(Sᵢₙ^{c})^{k+1} Equation 14

Therefore, when the averaged local fine-scale saturation equals the coarse-scale saturation for a given coarse-scale cell, the local boundary conditions determined by q^{c} and S^{c} via Equations 11 and 12 at time step k, will be updated by q^{c} and S^{c} at time step k+1.

The global transient solution is approximated by a series of steady state solutions. Therefore, the smaller the time interval, the better the approximation is. Standard local saturation boundary conditions of previous method, by contrast, only consider S_{bc}=1.0. Therefore, the local fine-scale saturation (Sᵢₙ^{ƒ})ⁿ increases only along the dashed horizontal line of S_{bc}=1.0, which is shown in FIG. 2. The time interval on which the local boundary conditions are updated considerably affects the flow results.

If the time interval is small enough, the change of the averaged local fine-scale saturation approximately equals that of the global coarse-scale saturation. From Equation 13, taking the derivative with respect to time t gives

$$\frac{d ( {S}_{bc}^{f} )}{d {S}_{i n}^{f}} \frac{d {S}_{i n}^{f}}{d t} = \frac{d ( {S}_{bc}^{c} )}{d {S}_{i n}^{c}} \frac{d {S}_{i n}^{c}}{d t} \qquad Equation 15$$

In FIG. 2, we see that if the time interval is very small, we have

$$\frac{d ( {S}_{bc}^{f} )}{d {S}_{i n}^{f}} \approx \frac{d ( {S}_{bc}^{c} )}{d {S}_{i n}^{c}} \qquad Equation 16$$

then it follows that

$$\frac{d {S}_{i n}^{f}}{d t} \approx \frac{d {S}_{i n}^{c}}{d t} \qquad Equation 17$$

Therefore, if the time interval is adequately small, the change of the averaged local fine-scale saturation is approximately the same as that of the coarse-scale saturation. The updating of local boundary conditions ensures that the temporal dependency of global flow is also taken into account in the local upscaling calculations. A time interval of 0.05 pore volumes injected (PVI) on the time scale of global coarse-scale simulation will be used herein, which gives satisfactory results.

Following the local fine-scale flow solution, the upscaled two-phase flow functions λ* and ƒ* can be numerically calculated to preserve the averaged fine-scale total flow rate and fractional flow. The total flow rate is preserved via the upscaled total mobility function λ*(S^{c}). By comparing Equations 5 and 7, λ*(S^{c}) needs to satisfy

λ*(S^{c})k*·∇p^{c}=λk·∇p=−u Equation 18

where u designates the averaged fine-scale total velocity. The x component in the above equation gives λₓ*(S^{c})kₓ*Δp^{c}/Δx^{c}=uₓ, where Δp^{c} represents a pressure difference (of opposite sign to ∇p^{c}). Therefore, λₓ*(S^{c}) can be computed as

$${λ}_{x}^{*} ( {S}^{c} ) = \frac{{\overline{u}}_{x}}{{k}_{x}^{*} Δ {p}^{c} / Δ {x}^{c}} = \frac{{\overline{u}}_{x} Δ {y}^{c} h}{( {k}_{x}^{*} Δ {p}^{c} / Δ {x}^{c} ) Δ {y}^{c} h} = \frac{{\overline{q}}_{x}}{{T}_{x}^{*} Δ {p}^{c}} \qquad Equation 19$$

where Δx^{c} and Δy^{c} designate the dimensions of a coarse-scale grid cell, h is the model thickness, qₓ is the total flux in the x direction, and kₓ* and Tₓ* are coarse-scale permeability and transmissibility in the x direction.

In a discrete form, λₓ* defined at the interface of two adjacent coarse-scale cells, such as i and i+1 shown in FIG. 1(B), is computed via

$${( {λ}_{x}^{*} ( {S}^{c} ) )}_{i + 1 / 2} = \frac{{〈 {q}_{x} 〉}_{i + 1 / 2}}{{( {\hat{T}}_{x}^{*} )}_{i + 1 / 2} ( {〈 p 〉}_{i} - {〈 p 〉}_{i + 1} )} \qquad Equation 20$$

where <qₓ> designates the integrated total fine-scale flux through the interface and <p> is the volume average of the fine-scale pressure over the coarse-scale cell. In the above equation, \hat{T}ₓ* represents an upscaled single-phase transmissibility, computed at the same time with the calculation of λₓ*. This is different than Tₓ*, which represents the upscaled transmissibility obtained from single-phase flow upscaling and is then applied later in global coarse-scale simulations. The quantity \hat{T}ₓ* is computed from the initial time of the local two-phase flow simulation when the system is still single-phase. In general, the value of \hat{T}ₓ* will be different than Tₓ* used in the coarse-scale simulation, which may be computed using different (local, quasi-global or global) single-phase upscaling approaches. The separate determination of λₓ* and Tₓ* decouples the single and two-phase upscaling computations.

For the coarse-scale transport equation, given by Equation 8, the upscaled fractional flow function ƒ*(S^{c}) is computed to preserve the averaged fractional flow uƒ in the volume averaged saturation equation, given by Equation 6. This can be written as

u^{c}ƒ*(S^{c})=uƒ Equation 21

The directional fractional flow function in the x direction can be determined via

$${f}_{x}^{*} ( {S}^{c} ) = \frac{\overline{{u}_{x} f}}{{\overline{u}}_{x}} \qquad Equation 22$$

And ƒₓ*(S^{c}), defined at the interface of two coarse-scale cells, is computed as

$${( {f}_{x}^{*} ( {S}^{c} ) )}_{i + 1 / 2} = \frac{{〈 {u}_{x} f 〉}_{i + 1 / 2}}{{〈 {u}_{x} 〉}_{i + 1 / 2}} = \frac{{〈 {q}_{xw} 〉}_{i + 1 / 2}}{{〈 {q}_{x} 〉}_{i + 1 / 2}} \qquad Equation 23$$

where <q_{xw}> and <qₓ> represent the integrated fine-scale water and total flux through the coarse-scale cell interface. Analogously, the quantities λ_{y}* and ƒ_{y}* can be computed with the local flow imposed in the y direction. Note that both λ* and ƒ* are dynamic quantities and are represented as functions of coarse-scale saturation S^{c}. The quantity S^{c} associated with λ* and ƒ* is computed as the average saturation over the fine-scale cells along the cell interface. This is to be consistent with the numerical scheme applied here, a second-order Total Variation-Diminishing (TVD) scheme.

With reference to FIG. 1, the overall local-global two-phase (LG2P) upscaling method can be summarized in algorithmic form as follows.
1. Solve global coarse-scale flow with generic boundary conditions (i.e., flow in the x or y direction) to obtain time-dependent coarse-scale solutions (q^{c})^{k} and (S^{c})^{k}, k=0, . . . ,K, where k represents a time step on the global coarse-scale, and K the end of global coarse-scale simulation. For the initial global solution, primitive coarse-scale models with fine-scale λ and ƒ are applied.
2. For a time step k, distribute the global coarse-scale solution (q^{c})^{k} and (S^{c})^{k} onto the local fine-scale boundaries to obtain local fine-scale boundary conditions (q^{ƒ}) and (S^{ƒ}) using Equations 11 and 12.
3. Solve local fine-scale flow problem subject to the local boundary conditions determined in step 2, and advance the solution with local fine-scale time step n.
4. For a prescribed saturation (computed by averaging the local fine-scale solution), compute the upscaled two-phase functions λ* and ƒ* via Equations 20 and 23, and output the saturation and upscaled functions.
5. Compute averaged fine-scale saturation over coarse-scale cell i(<Sᵢ^{ƒ}>ⁿ) and compare it with the corresponding global coarse-scale saturation at cell i((Sᵢ^{c})^{k+1}).
6. If <Sᵢ^{ƒ}>ⁿ<(Sᵢ^{c})^{k+1}, continue on step 3.
7. If <Sᵢ^{ƒ}>ⁿ≧(Sᵢ^{c})^{k+1} (and k<K), update the coarse-scale solution (q^{c} and S^{c}) in step 2 with q^{c} and S^{c} from time step k+1, and continue with step 2.
8. If needed, iterate on step 1 by solving the global coarse-scale flow with the newly computed coarse-scale two-phase functions λ* and ƒ*.

The LG2P upscaling approach uses generic flows in both the x and y directions to compute the x and y components of λ* and ƒ*. For the initial global coarse-scale solution, the primitive coarse-scale model can be used since the upscaled two-phase functions are not yet computed. However, the coarse-scale solutions computed from the primitive model may not be the best to estimate the local boundary conditions. Therefore, after the upscaled λ* and ƒ* are computed, the global coarse-scale flow can be solved again to obtain a new set of q^{c} and S^{c}, which can be expected to be more accurate than those from the primitive model. In fact, the entire procedure can be iterated on the global coarse-scale and local fine-scale solutions. For example, in all of the local global two-phase results presented later herein, one iteration was applied to compute λ* and ƒ*.

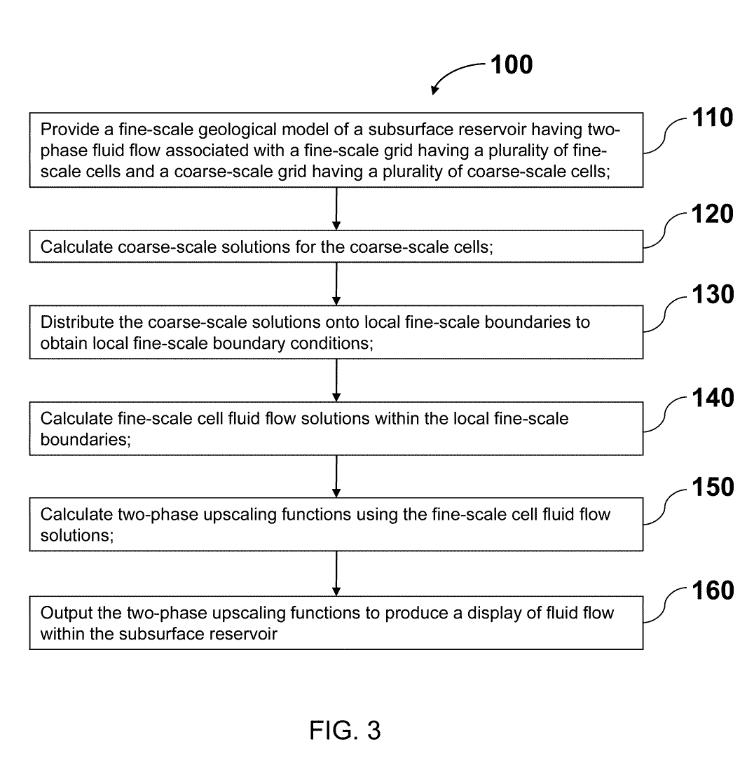

FIG. 3 illustratively condenses the above upscaling steps into a flow diagram. Upscaling method (100) includes providing a geological model for a subsurface reservoir having two-phase fluid flow that includes a fine-scale grid defining a plurality of fine-scale cells and a coarse-scale grid defining a plurality of coarse-scale cells (Step 110). The coarse-scale cells are typically aggregates of the fine-scale cells. Global coarse-scale solutions, such as fluxes and saturations, are computed for the coarse-scale cells by solving global flow subject to generic boundary conditions (Step 120). For example, the global coarse-scale solutions can be calculated using Equations 7 and 8. A primitive coarse-scale model can be utilized for solving the initial global solution. The coarse-scale solutions are distributed onto local fine-scale boundaries to obtain local fine-scale boundary conditions (Step 130). For example, the coarse-scale solutions can be interpolated onto local fine-scale boundaries using Equations 11 and 12. Fine-scale cell fluid flow solutions within the local fine-scale boundaries are calculated by solving the local fine-scale flow problem subject to the local fine-scale boundary conditions (Step 140). Two-phase upscaling functions are calculated using the fine-scale cell fluid flow solutions (Step 150). For example, the two-phase upscaled functions can include total flow and fractional flow functions, which can be computed using Equations 20 and 23, respectively. The two-phase upscaling functions are output to produce a display of fluid flow within the subsurface reservoir (Step 160). Examples of the display can include representations of saturation distributions, total flow functions, and fractional flow functions.

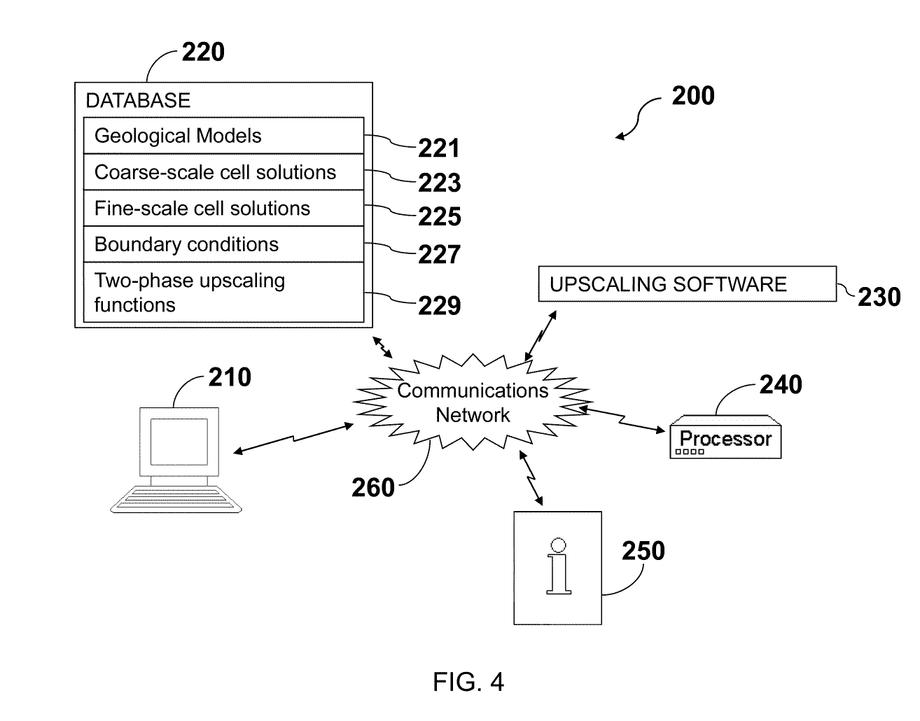

FIG. 4 illustrates a system 200 that can perform upscaling of a fine-scale geological model having two-phase fluid flow as described by the method above. System 200 includes user interface 210, such that an operator can actively input information and review operations of system 200. User interface 210 can be any means in which a person is capable of interacting with system 200 such as a keyboard, mouse, or touch-screen display. Input that is entered into system 200 through user interface 210 can be stored in a database 220. Additionally, any information generated by system 200 can also be stored in database 220. For example, database 220 can store user-defined parameters, as well as, system generated computed solutions. Accordingly, geological models 221, coarse-scale cell fluid flow solutions 223, fine-scale cell fluid flow solutions 225, boundary conditions 227, and two-phase upscaling functions 229 are all examples of information that can be stored in database 220.

System 200 includes software 230 that is stored on a processor readable medium. Current examples of a processor readable medium include, but are not limited to, an electronic circuit, a semiconductor memory device, a ROM, a flash memory, an erasable programmable ROM (EPROM), a floppy diskette, a compact disk (CD-ROM), an optical disk, a hard disk, and a fiber optic medium. As will be described more fully herein, software 230 is capable of upscaling a fine-scale geological model. Processor 240 interprets instructions to execute software 230, as well as, generates automatic instructions to execute software for system 200 responsive to predetermined conditions. Instructions from both user interface 210 and software 230 are processed by processor 240 for operation of system 200. In some embodiments, a plurality of processors can be utilized such that system operations can be executed more rapidly.

In certain embodiments, system 200 can include reporting unit 250 to provide information to the operator or to other systems (not shown). For example, reporting unit 250 can be a printer, display screen, or a data storage device. However, it should be understood that system 200 need not include reporting unit 250, and alternatively user interface 210 can be utilized for reporting information of system 200 to the operator.

Communication between any components of system 200, such as user interface 210, database 220, software 230, processor 240 and reporting unit 250, can be transferred over a communications network 260. Communications network 260 can be any means that allows for information transfer. Examples of such a communications network 260 presently include, but are not limited to, a switch within a computer, a personal area network (PAN), a local area network (LAN), a wide area network (WAN), and a global area network (GAN). Communications network 260 can also include any hardware technology used to connect the individual devices in the network, such as an optical cable or wireless radio frequency.

In operation, an operator initiates software 230, through user interface 210, to upscale a geological model 221, which is stored in database 220. Software 230 computes time-dependent coarse-scale cell fluid flow solutions 223, such as fluxes and saturations, and distributes them onto local fine-scale boundaries to obtain local fine-scale boundary conditions 227. Software 230 computes fine-scale cell fluid flow solutions 225 within the local fine-scale boundaries using the local fine-scale boundary conditions 227. Software 230 computes two-phase upscaling functions with the fine-scale cell fluid flow solutions 225. A visual display of fluid flow within the subsurface reservoir can be produced from the computed two-phase upscaling functions. For example, the display may illustrate fractional flow and total flow functions.

### EXAMPLES

The results of the local-global two-phase upscaling are presented for different cases including permeability distributions with different correlation lengths and cases including different fluid-mobility ratios. The local-global two-phase upscaling method is also applied to multiple permeability realizations and the statistics of flow results are compared. Correlation lengths can be considered the distances from a particular point beyond which there is no further correlation of a physical property, such as permeability, associated with that point. The values for a given property at distances beyond the correlation lengths can therefore be considered random. The permeability distributions presented herein were generated using sequential Gaussian simulation. The horizontal correlation length is given by lₓ, the vertical correlation length is given by l_{y}, and the standard deviation, σ_{logk}, is such that σ² is the variance of log k. For all the cases, a two-dimensional model having 100×100 fine-scale cells is coarsened with an upscaling ratio of 10 in each dimension to obtain a coarse-scale model having 10×10 coarse-scale cells. The flow results are obtained through application of dimensionless time, given by pore volume injected (PVI), which can be mathematically expressed as Vₚ/1 ∫₀^{t}Q(τ)dτ, where Vₚ is the total pore volume.

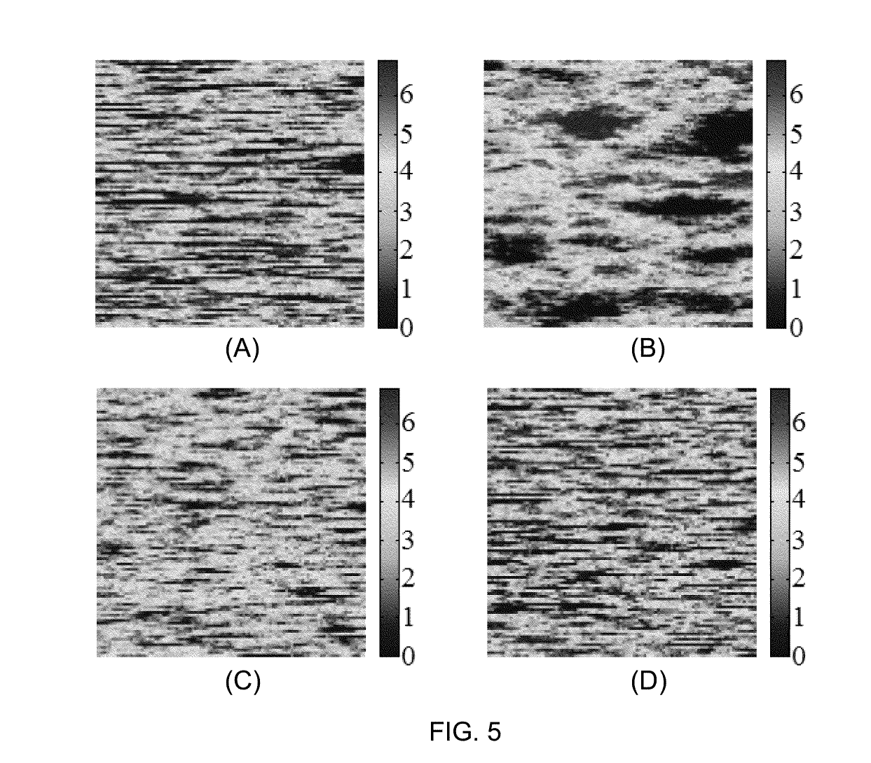

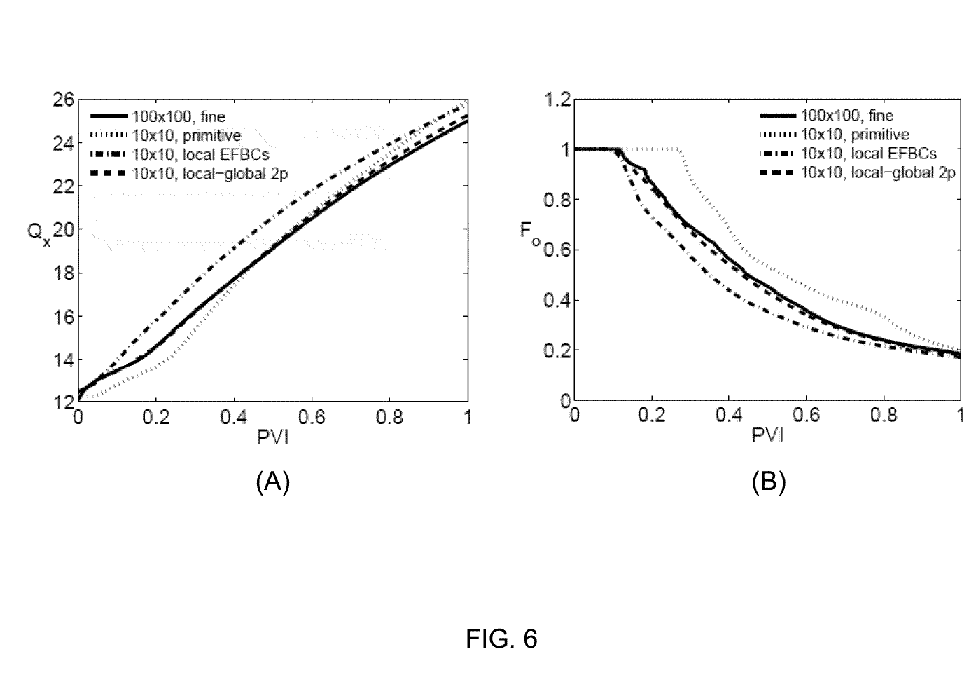

FIG. 5(A) illustrates a domain with a lognormal permeability distribution with dimensionless correlation lengths lₓ=0.4 and l_{y}=0.01, and with σ_{logk}=2. The results of local-global two-phase upscaling are presented in FIG. 6. FIG. 6 also compares these results to those of the primitive model and the upscaling method employing local effective flux boundary conditions (EFBCs). The primitive model typically gives underestimated total flow rate and late breakthrough in oil fractional flow. The EFBCs upscaling method typically shows an overestimation of total flow rate and a biased oil fractional flow toward early breakthrough. The local-global two-phase upscaling results, denoted by the dashed curve in FIG. 6, captures the fine-scale solutions very well for both total flow rate (FIG. 6A) and oil fractional flow predictions (FIG. 6B). It shows comparable accuracy to the global two-phase upscaling method, but with significant computational savings, as the local-global two-phase upscaling method avoids solving any global fine-scale two-phase flow. This example demonstrates the efficacy of the local-global two-phase upscaling approach.

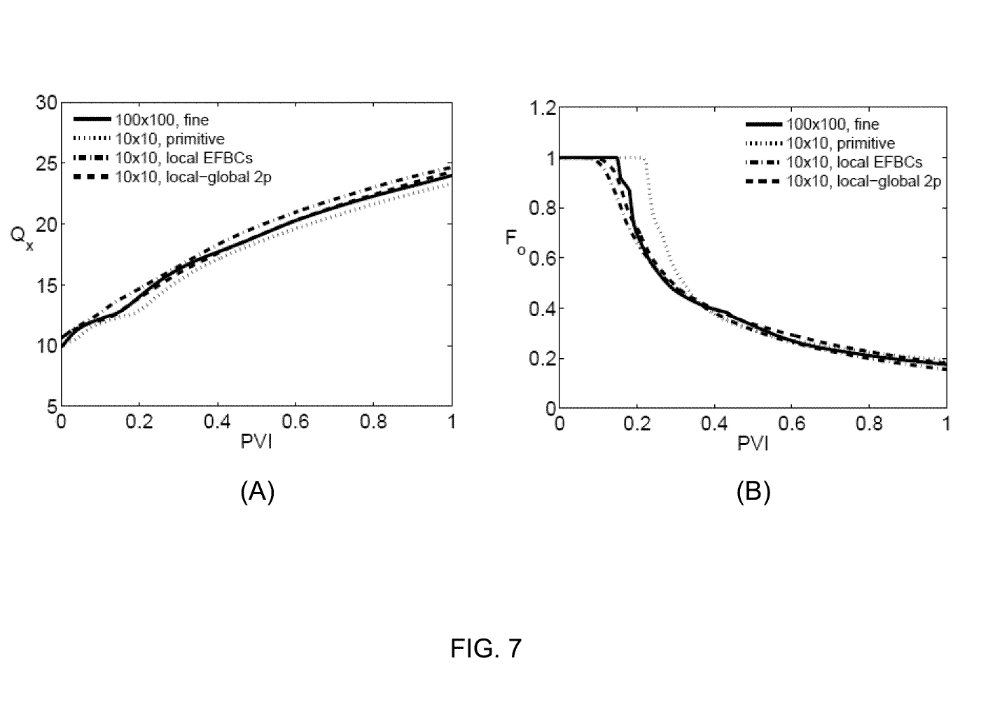

FIG. 5(B) illustrates a permeability field characterized by relatively long correlation lengths lₓ=0.5 and l_{y}=0.1, and with σ_{logk}=2. This domain has a more blocky appearance than that shown in FIG. 5(A), since here the vertical correlation length is 10 times more. Similar to the previous example, the three different upscaled coarse-scale models are compared with the fine-scale reference solution. The results are shown in FIG. 7. The EFBC upscaling method (dot-dash curve) provides a solution close to the fine-scale results (solid curve) and provides significant improvement over standard boundary conditions given by the primitive coarse-scale model (dot curve). This may be due to the EFBCs approximately accounting for global flow effects in the pressure equation. Accordingly, the EFBC method may be appropriate for domains having relatively long correlation lengths in the vertical direction, as in the permeability field of this example. The local-global two-phase upscaling method (dash curve) further improves the results compared to the EFBC method and produces very accurate predictions. The local-global two-phase upscaling incorporates the global dependency of both pressure and saturation, and therefore, is able to better capture the fine-scale solutions for general cases in different parameter ranges.

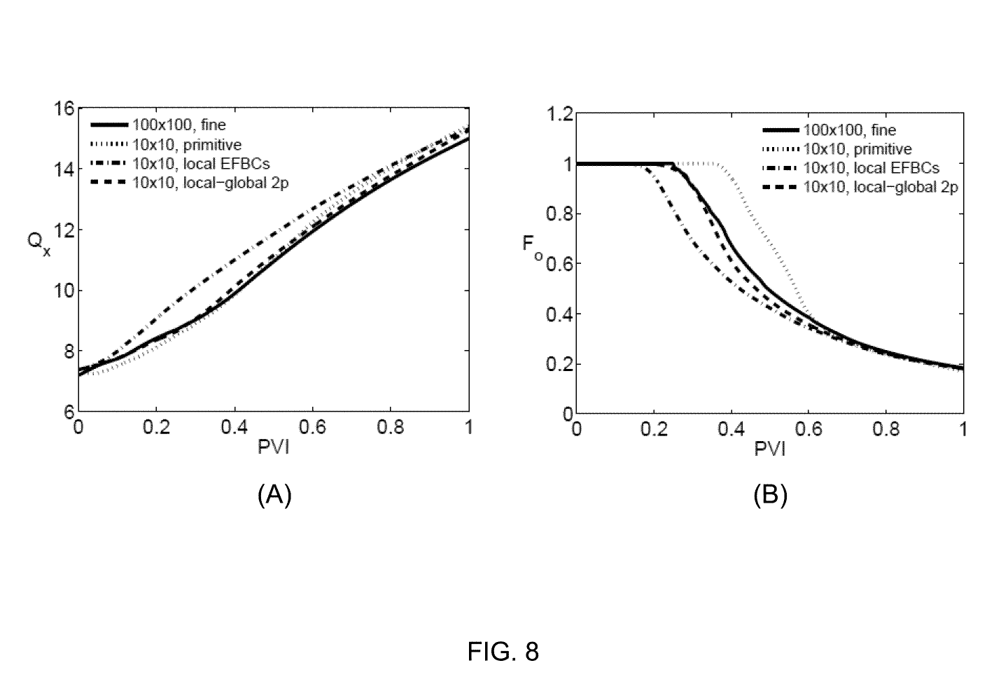

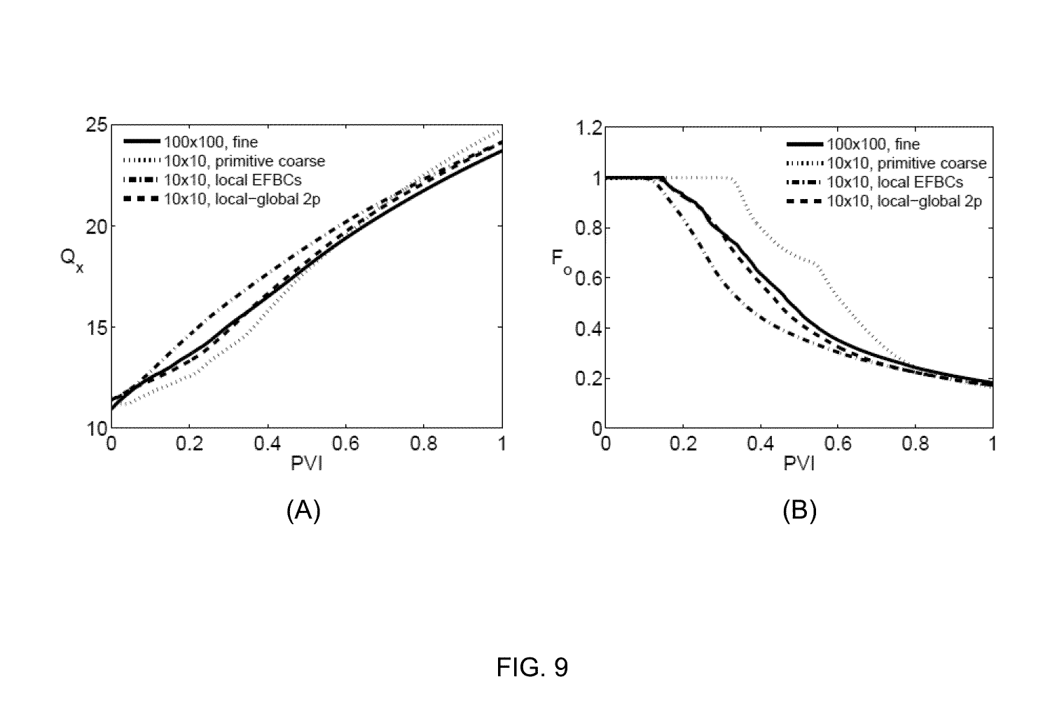

FIGS. 5(C) and 5(D) illustrate two log normal permeability fields, σ_{logk}=2, characterized by very short correlation lengths in the vertical direction (l_{y}=0.02 and l_{y}=0.01, respectively), and horizontal correlation lengths that are also shorter than the previous two examples (lₓ=0.2 and lₓ=0.25, respectively). FIGS. 8 and 9 show corresponding simulation results for these permeability fields, respectively. Similar to the first example with a permeability field having lₓ=0.4 and l_{y}=0.01, shown in FIG. 5(A), the EFBC upscaling method (dot-dash curve) gives an overestimated flow rate and biased oil fractional flow predictions towards an early breakthrough. These biases are corrected when using the local-global two-phase upscaling method (dash curves), which provides a coarse-scale model that is very close to the fine-scale reference solution.

In the examples presented so far, a moderate fluid-mobility ratio of M=5 has been considered, which is typical in oil-water flow. In FIGS. 6-9, the errors associated with the primitive coarse-scale model mainly exist in the oil fractional flow predictions, whereas the errors in the total flow rate are relatively small. This is due to the fact that for all the examples, the primitive coarse-scale model employed the most accurate single-phase (global transmissibility) upscaling method. As will be seen in the following examples, for cases with moderate mobility ratios, the accuracy of upscaled single-phase flow parameters has a dominant impact on the accuracy of two-phase flow results. Higher mobility ratios, such as M=50 or M=100, are typically encountered in gas injections for hydrocarbon recoveries from petroleum reservoirs.

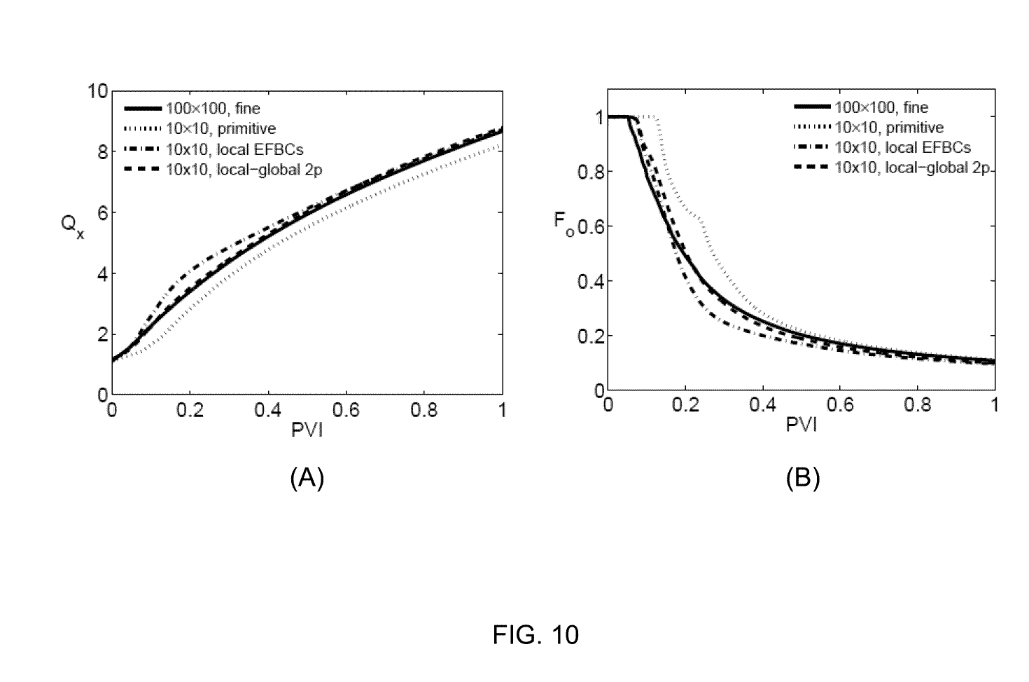

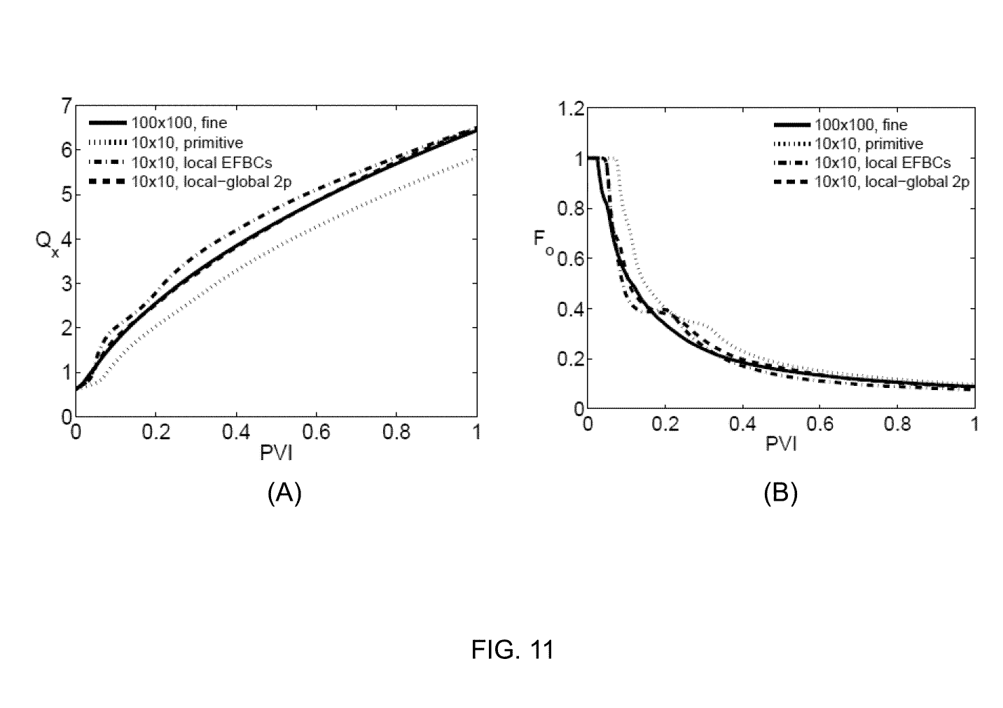

FIG. 10 illustrates results of the previously discussed upscaling methods using a mobility ratio of M=50 and the permeability field shown in FIG. 5(D), which has correlation lengths of lₓ=0.25 and l_{y}=0.01. FIG. 11 similarly illustrates results of the previously discussed upscaling methods using a mobility ratio of M=100 and the permeability field shown in FIG. 5(A), which has correlation lengths of lₓ=0.4 and l_{y}=0.01.

FIGS. 10(A) and 11(A) show how the total flow rate is impacted for each upscaling method when a higher mobility ratio is used. The upscaled two-phase functions considerably affect the results of total flow rate for the primitive coarse-scale model. For example, the accuracy of the total flow rate when the system is still of single-phase flow, where the pore volumes injected is zero, is determined accurately by the upscaled single-phase flow parameters. The primitive coarse-scale model (dot curves) shows evident errors during the course of simulation as the upscaled two-phase functions act to account for the multiphase flow effects. The EFBC two-phase upscaling method (dot-dash curves) over estimates the total flow rate. The local-global two-phase upscaling method (dash curves) consistently corrects errors as the simulation time evolves, and shows very close predictions to the fine-scale reference model.

FIGS. 10(B) and 11(B) show the results for oil fractional flow with M=50 and M=100, respectively. Compared to the previous examples, the injected water breaks through very fast due to the very high-mobility ratios, which is illustrated by the fine-scale reference solutions. The primitive coarse-scale model again shows biased predictions towards late breakthrough, though the errors are not as large as the previous examples. Both EFBC two-phase upscaling and the local-global two-phase upscaling correct the errors in the primitive model, especially by better capturing the breakthrough time. For these cases (M=50 and M=100), the errors associated with EFBC local upscaling are much smaller than the cases with M=5. The LG2P upscaling again outperforms the EFBC local upscaling, consistently showing improvements over local methods.

Flow simulations over multiple permeability realizations, which are often required for uncertainty quantification in subsurface modeling, are compared to assess the accuracy of a coarse-scale model. The permeability field shown in FIG. 5(A), which is characterized by correlation lengths of lₓ=0.4 and l_{y}=0.01, is used to generate 100 realizations of the fine-scale model (unconditional to any data). The various coarse-scale models are then applied to each realization. The flow results over the 100 realizations are represented by ensemble statistics using P10, P50 and P90 confidence intervals, as often done in uncertainty quantification.

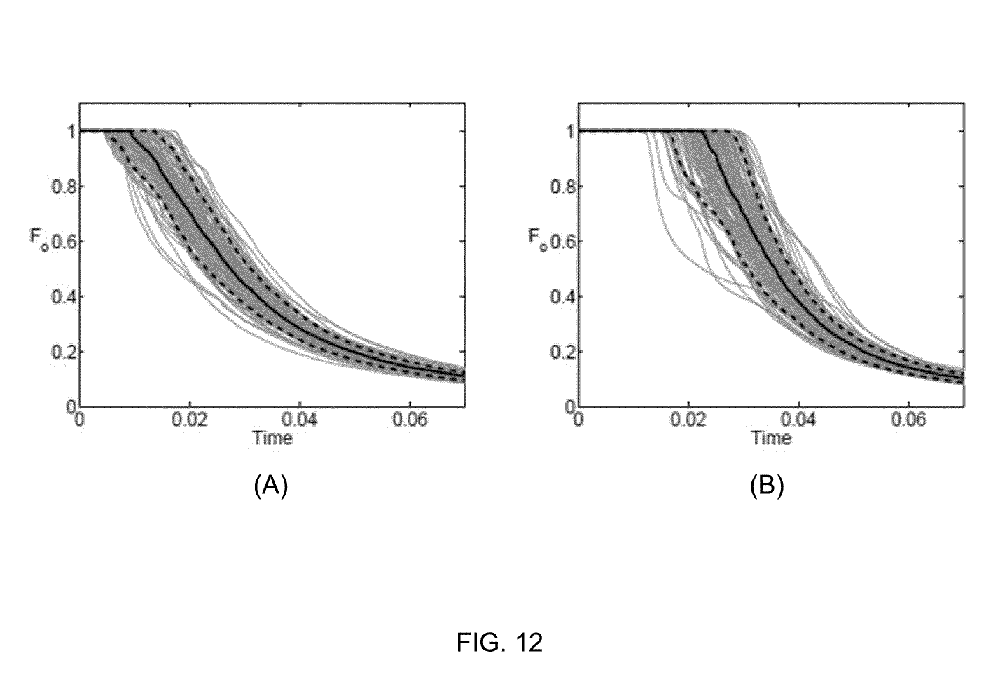

FIG. 12 shows the fine-scale and coarse-scale results for oil fractional flow (gray curves) for the 100 realizations. The solid black curve represents the P50 flow predictions and the dashed black curves represent the P10 (lower curves) and P90 (upper curves) responses. FIG. 12A shows the fine-scale predictions, while FIG. 12(B) shows the primitive coarse-scale model predictions. While there are variations among the different realizations, of greater interest are key statistics of the flow responses, such as the P50 and P10-P90 confidence interval.

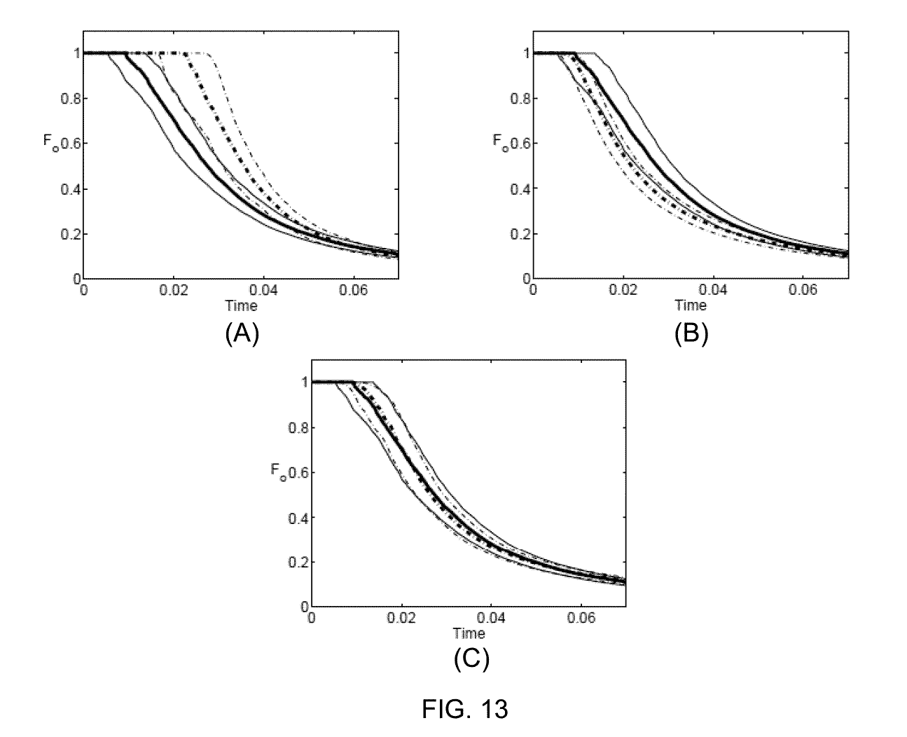

FIGS. 13(A-C) illustrate the comparisons of fine-scale confidence intervals with confidence intervals for the primitive coarse-scale model, EFBC two-phase upscaling model, and local-global two-phase upscaling method, respectively. In FIGS. 13(A-C), the solid curves correspond to the fine-scale model results and the dot-dash curves correspond to the coarse-scale model results. The thick curves represent the P50 confidence interval and the thin curves the P10 (lower curves) and P90 (upper curves) flow responses. In FIG. 13(A), the primitive coarse-scale model shows large errors in comparison to the fine-scale model, as clearly seen by the predicted P10-P90 intervals barely overlapping. The EFBC upscaling method, as shown in FIG. 13(B), shows improved results compared to the primitive model and corrects the bias towards a late breakthrough. The EFBC upscaling method has a bias towards an early breakthrough and the predicted uncertainty range is much narrower than that in the fine-scale model. The biased results in the P50 and P10-P90 interval illustrate the biased prediction in each realization using EFBC upscaling. FIG. 13(C) shows results for the local-global two-phase upscaling method. This method captures the fine-scale P50 and P10-P90 predictions very well. The coarse-scale models reproduce the P50 of fine-scale solution, and capture the P10-P90 uncertainty range.

In these examples, the local-global two-phase upscaling method provides reasonable accuracy for various reservoir conditions. Two-phase transport functions are upscaled accurately by using global coarse-scale flow solutions to determine local boundary conditions for both pressure and saturation equations in the local two-phase upscaling calculations. The local boundary conditions are updated with the time-dependent coarse-scale solutions, therefore capturing the global flow effects both spatially and temporally.

The local-global two-phase upscaling method provides accurate coarse-scale solutions with reference to the fine-scale solution. It consistently outperforms previous local or extended local upscaling methods, such as upscaling using effective flux boundary conditions, by correcting the bias of overestimated total flow rate and the bias towards early breakthrough in these local methods. In particular, the local-global two-phase upscaling method accounts for the global dependency of saturation, which has a strong impact on upscaled transport functions in the coarse-scale modeling of subsurface flow and transport. This effect is unique to the upscaling of multiphase flow, and has not effectively been accounted for in these previous local two-phase upscaling methods.

The local-global two-phase upscaling method shows comparable accuracy to the global two-phase upscaling, but with reduced computational cost. The computational cost associated with the local-global two-phase upscaling method is reasonable, as the local-global two-phase upscaling method avoids solving global fine-scale two-phase flow, which makes the method much more efficient. Although the computational cost is higher compared to standard local two-phase upscaling procedures, it is small compared to full fine-scale multiphase flow simulation.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. For example, different treatments could be utilized to determine the local boundary conditions. As described herein, only the inlet and outlet boundary conditions for fluxes and saturations are determined from the global coarse-scale flow based on single-phase time of flight. No-flow conditions are also imposed for boundaries that are parallel to the flow directions. Other procedures, such as the use of pressures and interpolation of the coarse-scale solutions onto all of the local boundaries could be used. Additionally, other interpolation schemes could be implemented. The local-global two-phase upscaling method can also be extended to adjust the upscaled two-phase functions based on the actual global boundary conditions, including well-driven flows.

What is claimed is:

1. A quasi-global two-phase method for upscaling a fine-scale geological model of a subsurface reservoir, the method comprising:
(a) providing a fine-scale geological model of a subsurface reservoir having two-phase fluid flow associated with a fine-scale grid having a plurality of fine-scale cells and a coarse-scale grid having a plurality of coarse-scale cells;
(b) calculating fluxes and saturations for the coarse-scale cells;
(c) distributing the fluxes and saturations onto local fine-scale boundaries to obtain local fine-scale boundary conditions;
(d) calculating fine-scale cell fluid flow solutions within the local fine-scale boundaries responsive to the local fine-scale boundary conditions;
(e) calculating two-phase upscaling functions responsive to the fine-scale cell fluid flow solutions; and
(f) outputting the two-phase upscaling functions to produce a display of fluid flow within the subsurface reservoir.

2. The method of claim 1, wherein the fluxes and saturations calculated in step (b) are time-dependent.

3. The method of claim 1, wherein the fluxes and saturations are calculated in step (b) using a primitive coarse-scale model.

4. The method of claim 1, further comprising:
(g) solving coarse-scale flow using the two-phase upscaling functions to calculate updated fluxes and saturations; and
(h) repeating steps (c)-(f) using the updated fluxes and saturations.

5. The method of claim 1, wherein the fluxes and saturations are distributed onto local fine-scale boundaries in step (c) using a time-of-flight interpolation scheme.

6. The method of claim 1, wherein the fine-scale cell fluid flow solutions are averaged or integrated to calculate the two-phase upscaling functions in step (e).

7. The method of claim 1, wherein the two-phase upscaling functions include fractional flow and total flow functions.

8. A computer-implemented method for upscaling a fine-scale geological model of a subsurface reservoir, the method comprising:
(a) providing a fine-scale geological model of a subsurface reservoir having two-phase fluid flow associated with a fine-scale grid having a plurality of fine-scale cells and a coarse-scale grid having a plurality of coarse-scale cells;
(b) computing time-dependent coarse-scale cell fluid flow solutions at a coarse-scale time-step;
(c) distributing the coarse-scale cell fluid flow solutions at the coarse-scale time-step onto local fine-scale boundaries to obtain local fine-scale boundary conditions;
(d) computing fine-scale cell fluid flow solutions within the local fine-scale boundaries at a fine-scale time-step responsive to the local fine-scale boundary conditions;
(e) computing time-dependent coarse-scale cell two-phase fluid flow functions responsive to the fine-scale cell fluid flow solutions; and
(f) outputting a display of fluid flow within the subsurface reservoir responsive to the time-dependent coarse-scale cell two-phase fluid flow functions.

9. The method of claim 8, further comprising:
(g) solving coarse-scale flow using the time-dependent coarse-scale cell two-phase fluid flow functions to compute updated time-dependent coarse-scale cell fluid flow solutions; and
(h) repeating steps (c)-(f) using the updated time-dependent coarse-scale cell fluid flow solutions.

10. The method of claim 8, wherein the fine-scale time-step is advanced and steps (d) and (e) are repeated when an average of the fine-scale cell fluid flow solutions within the local fine-scale boundaries for the coarse-scale cells is less than the time-dependent coarse-scale cell fluid flow solutions at the time step following the time-dependent coarse-scale cell fluid flow solutions computed in step (b).

11. The method of claim 8, wherein steps (c)-(f) are repeated when an average of the fine-scale cell fluid flow solutions within the local fine-scale boundaries for the coarse-scale cells is at least equal to the time-dependent coarse-scale cell fluid flow solutions at the time step following the time-dependent coarse-scale cell fluid flow solutions computed in step (b).

12. The method of claim 8, wherein the time-dependent coarse-scale cell fluid flow solutions in step (b) are computed using a primitive coarse-scale model.

13. The method of claim 8, wherein the time-dependent coarse-scale cell fluid flow solutions in step (b) comprise fluxes and saturations.

14. The method of claim 8, wherein the time-dependent coarse-scale cell fluid flow solutions in step (b) are distributed onto local fine-scale boundaries in step (c) using a time-of-flight interpolation scheme.

15. The method of claim 8, wherein the display of fluid flow within the subsurface reservoir comprises a representation of fractional flow and total flow functions.

16. A system for upscaling a fine-scale geological model of subsurface reservoir, the system comprising:
a database configured to store data comprising a fine-scale geological model of a subsurface reservoir having two-phase fluid flow associated with a fine-scale grid having a plurality of fine-scale cells and a coarse-scale grid having a plurality of coarse-scale cells:
a computer processer configured to receive the stored data from the database, and to execute software responsive to the stored data;
a software program executable on the computer processer, the software program configured for
(a) computing coarse-scale cell fluid flow solutions;
(b) distributing the coarse-scale cell fluid flow solutions onto local fine-scale boundaries to obtain local fine-scale boundary conditions;
(c) computing fine-scale cell fluid flow solutions within the local fine-scale boundaries responsive to the local fine-scale boundary conditions: and
(d) computing two-phase upscaling functions responsive to the fine-scale cell fluid flow solutions; and
a visual display for displaying system outputs.

17. The system of claim 16, wherein the coarse-scale cell fluid flow solutions comprise fluxes and saturations.

18. The system of claim 16, wherein the software program distributes the coarse-scale cell fluid flow solutions onto the local fine-scale boundaries using a time-of-flight interpolation scheme.

19. The system of claim 16, wherein the system outputs displayed by the visual display comprise the computed two-phase upscaling functions.

20. The system of claim 16, wherein the system outputs displayed by the visual display comprise fractional flow and total flow functions.
